(19) United States
(12) Patent Application Publication
(10) Pub. No.: US 2007/0097061 A1
(43) Pub. Date: May 3, 2007

(54) Display device

(76) Inventor: Toshiyuki Kurita, Yokohama (JP)

Correspondence Address: MCDERMOTT WILL & EMERY LLP, 600 13TH STREET, N.W., WASHINGTON, DC, 20005-3096, US

(21) Appl. No.: 11/518,517

(22) Filed: Sep. 11, 2006

(30) Foreign Application Priority Data
Oct. 28, 2005 (JP) 2005-313690

(51) Int. Cl. G09G 3/36

(52) U.S. Cl. 345/99

(57) ABSTRACT

A display apparatus includes scan lines, a scan line driving circuit connected to at least left or right ends of the scan lines so as to apply a scan voltage to the scan lines, data lines, a data line driving circuit connected to the data lines to apply a driving voltage to the data lines in accordance with an inputted video signal, electron emitting elements connected to intersection portions between the scan lines and the data lines respectively to emit electrons in accordance with a potential difference between the scan voltage and the driving voltage, and a control module, wherein the control module controls the scan line driving circuit and/or the data line driving circuit to apply a reverse-polarity voltage to the electron emitting elements in accordance with the electron emitting elements, the reverse-polarity voltage having reverse polarity to the voltage applied to the electron emitting elements.

### BACKGROUND OF THE INVENTION

The present invention relates to a display apparatus having thin film type electron emitting elements, for example, each constituted by an upper electrode, an electron acceleration layer and a lower electrode.

For example, JP-A-8-248921 discloses a display apparatus using a matrix type display panel where electron emitting elements serving as pixels are arrayed in a matrix. In JP-A-8-248921, surface conduction type electron emitting elements are used as the electron emitting elements. A plurality of electron emitting elements are arrayed in a matrix so as to be located in intersection portions between a plurality of row electrodes (scan lines) extending in a row direction (horizontal direction on screen) and a plurality of column electrodes (data lines) extending in a column direction (vertically on screen), so as to form a display panel. A scan signal (scan pulse) is applied to the scan lines so as to select electron emitting elements by row (in this sense, the scan signal will be also referred to as “selection signal”). At the same time, a driving signal based on a vide signal is supplied to electron emitting elements of the selected row so as to allow the electron emitting elements to emit electrons. The electrons are brought into collision against phosphors disposed oppositely to the electron emitting elements so that the phosphors emit light. The operation to select a scan line and the operation to supply a driving signal based on a video signal in sync with the selection operation are performed sequentially on all the scan lines by scan line. Thus, a video image of one frame (or one field) is formed. As the method for supplying a driving signal, for example, there has been known a method in which a driving signal is supplied to each scan line sequentially from the scan line on the top of a screen of the display panel toward the scan line at the bottom of the screen. Various electron emitting elements have been proposed as well as the aforementioned surface conduction type electron emitting elements. One of them is a thin film type electron emitting element. In the thin film type electron emitting element, for example, a thin film has a three-layer structure composed of an upper electrode, an insulating layer and a lower layer, and a predetermined voltage is applied between the upper electrode and the lower electrode so as to emit electrons into a vacuum from the surface of the upper electrode, as disclosed in Paragraph 0003 of JP-A-11-095716. The electron emitting element may be regarded as an electron emitting element having an upper electrode, a lower electrode and an electron acceleration layer disposed therebetween. Here, the insulating layer in JP-A-11-095716 corresponds to the electron acceleration layer.

Other examples of thin film type electron emitting elements include MIM (Metal-Insulator-Metal) type electron emitting elements using metal as upper and lower electrodes, MIS (Metal-Insulator-Semiconductor) type electron emitting elements using semiconductor as at least one of electrodes, electron emitting elements using a laminated film of insulator and semiconductor in place of the insulating layer, that is, having a four-layer structure of an upper electrode, an insulating layer, a semiconductor layer and a lower electrode as a whole, etc.

These thin film type electron emitting elements have the property of easily accumulating charges in the insulating layer or a layer taking the place of the insulating layer.

Therefore, the aforementioned JP-A-11-095716 discloses the following method for elongating the lives of thin film type electron emitting elements in a display apparatus using a matrix type display panel where the electron emitting elements serving as pixels are arrayed in a matrix. That is, a signal (hereinafter referred to as “reverse-polarity signal”) whose polarity is reverse to the polarity of a scan signal (scan pulse) for applying a voltage in a direction (polarity) to allow a scan line to emit electrons is applied, for example, in a vertical non-display interval (also referred to as “vertical blanking interval”, and hereinafter often referred to as “non-display interval” simply) so as to prevent trapped electrons from being accumulated into an impurity level or a defect level in each insulating layer and reduce the deterioration of each electron emitting element. Thus, the life of the electron emitting element can be elongated.

### SUMMARY OF THE INVENTION

According to the aforementioned technique disclosed in JP-A-11-095716, a reverse bias voltage is applied to each electron emitting element of the display apparatus in order to prevent charges from being accumulated in the insulating layer (or a layer taking the place of the insulating layer). There is, however, no consideration about the fact that a reverse bias voltage applied to one electron emitting element differs from that applied to another electron emitting element due to the resistance of the scan line.

The present invention was developed in consideration of the aforementioned problem. An object of the invention is to provide a display apparatus in which the life of the display screen can be elongated.

In order to attain the object, a display apparatus according to the invention includes a plurality of scan lines, a scan line driving circuit connected to at least left or right ends of the plurality of scan lines so as to apply a scan voltage to the plurality of scan lines, a plurality of data lines, a data line driving circuit connected to the plurality of data lines so as to apply a driving voltage to the plurality of data lines in accordance with an inputted video signal, electron emitting elements connected to intersection portions between the plurality of scan lines and the plurality of data lines respectively so as to emit electrons in accordance with a potential difference between the scan voltage and the driving voltage, and a control module, wherein the control module controls the scan line driving circuit and/or the data line driving circuit so as to apply a reverse-polarity voltage to the electron emitting elements in accordance with the electron emitting elements, the reverse-polarity voltage having reverse polarity to the voltage applied to the electron emitting elements. With this configuration, the reverse-polarity voltage can be applied all over the screen.

### BRIEF DESCRIPTION OF THE DRAWINGS

These and other features, objects and advantages of the present invention will become more apparent from the following description when taken in conjunction with the accompanying drawings wherein:

FIG. 1 is a block configuration diagram showing a first embodiment of a display apparatus according to the present invention;

FIGS. 2A-2C are diagrams for explaining the influence of wiring resistance;

FIG. 3 is a diagram for explaining an idea for elongating the lives of electron emitting elements;

FIG. 4 is a chart for explaining an operation for elongating the lives of the electron emitting elements;

FIG. 5 is a block configuration diagram showing a second embodiment of a display apparatus according to the present invention;

FIG. 6 is a chart for explaining an operation for elongating the lives of electron emitting elements;

FIG. 7 is a chart for explaining an operation for elongating the lives of the electron emitting elements;

FIG. 8 is a chart for explaining an operation for elongating the lives of the electron emitting elements; and

FIG. 9 is a chart for explaining an operation for elongating the lives of the electron emitting elements.

### DETAILED DESCRIPTION OF EMBODIMENTS

Several embodiments of the present invention will be described below with reference to the drawings. Constituents having similar functions are referenced correspondingly among the drawings, and in order to avoid redundancy, parts described once will not be. described repeatedly.

### [Emodiment 1]

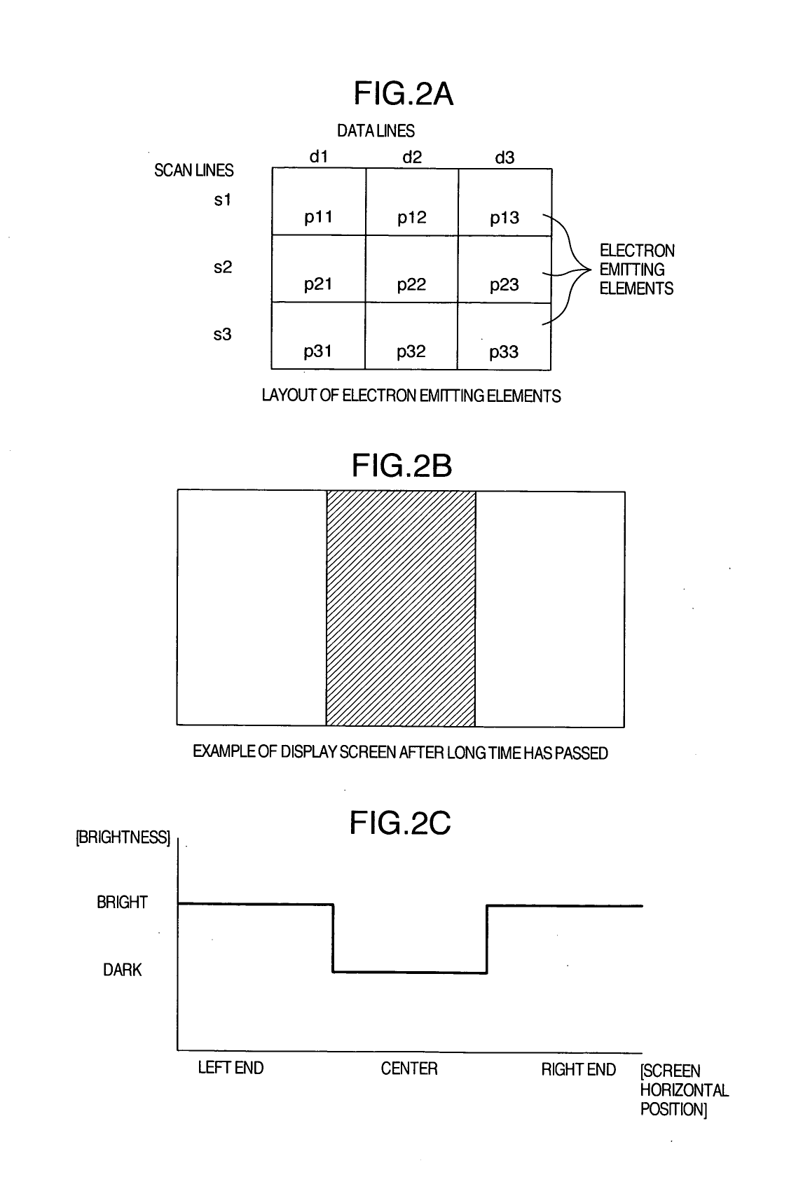

Taking into consideration the fact that a reverse bias voltage applied to one electron emitting element differs from that applied to another electron emitting element due to the resistance of a scan line, this embodiment is to control the reverse bias voltage applied to each electron emitting element. To this end, first, description will be made on the influence of the resistance of the scan line with reference to FIGS. 2A-2C. First, assume that a display apparatus has a display screen where the number of scan lines is three and the number of data lines is three. When a reverse-polarity pulse is applied to this display apparatus in a vertical non-display interval, trapped electrons can be prevented from being accumulated. Thus, the life of the display apparatus is elongated. As shown in FIG. 2B, however, there arises a problem that the center portion of the screen becomes darker than either end portion of the screen. This problem arises from the following fact. That is, since the reverse-polarity pulse is applied through each scan line, due to the resistance of the scan line, the reverse bias voltage applied to each electron emitting element in the center portion of the screen is lower than the reverse bias voltage applied to each electron emitting element in the end portion of the screen. In other words, the voltage applied to each electron emitting element in the end portion of the screen in order to restore the life thereof differs from the voltage applied to each electron emitting element in the center portion of the screen likewise. As a result, there arises a difference in deterioration between the electron emitting elements after a long time has passed. There also arises a problem that the life of each electron emitting element in the center portion of the screen differs from that of each electron emitting element in the end portion of the screen.

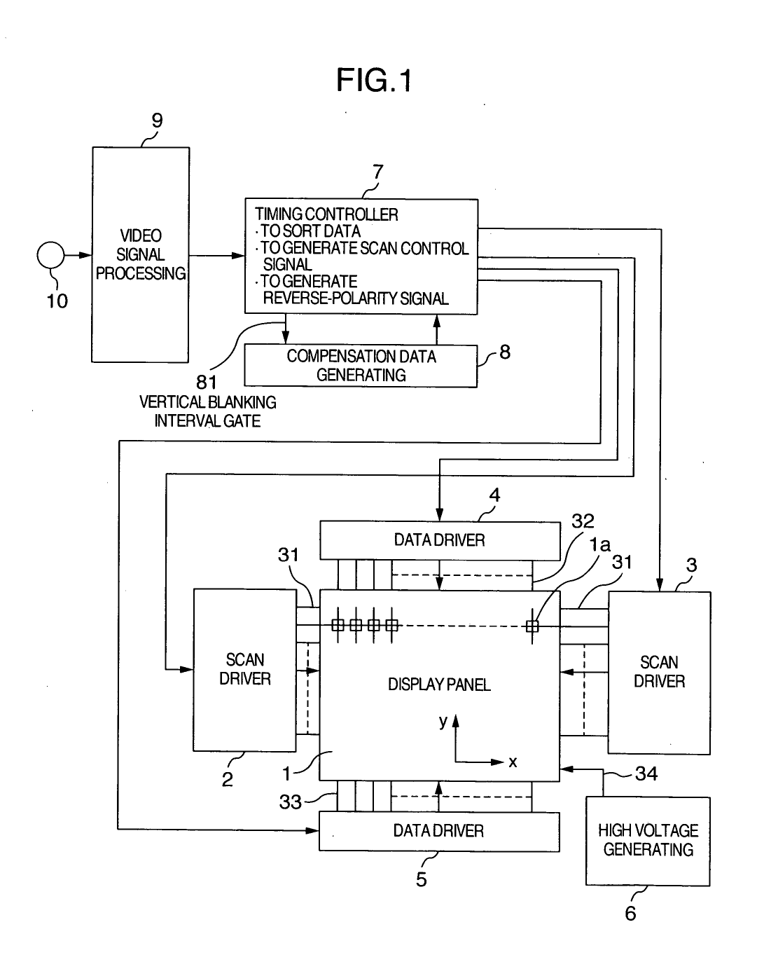

FIG. 1 is a block diagram showing a first embodiment of a display apparatus according to the present invention, which is characterized by including a compensation data generating circuit 8 and a timing controller 7. The compensation data generating circuit 8 generates data for compensating resistant components of scan lines so as to elongate the life of the display apparatus. The timing controller 7 has a reverse-polarity signal generating function.

As shown in FIG. 1, the display apparatus according to the invention is constituted by a display panel 1, scan drivers (scan line driving circuits) 2 and 3, data drivers (data line driving circuits) 4 and 5, a high voltage generating circuit 6, a video signal processing circuit 9, a compensation data generating circuit 8 and a timing controller 7 (control circuit). The display panel 1 has a plurality of thin film type electron emitting elements arrayed in a matrix. The scan drivers 2 and 3 and the data drivers 4 and 5 drive the display panel 1. The high voltage generating circuit 6 generates a high acceleration voltage to be applied to the display panel 1. The video signal processing circuit 9 performs predetermined signal processing upon a video signal inputted from a video input terminal 10, so that the processed video signal can be displayed on the display panel 1. The compensation data generating circuit 8 generates data for compensating a resistant component of each scan line so as to elongate the life of the display apparatus. The timing controller 7 controls the scan drivers 2 and 3 and the data drivers 4 and 5 in accordance with the input video signal.

First, description will be made on the display panel 1, the scan drivers 2 and 3 and the data drivers 4 and 5 serving as driving circuits of the display panel 1, and the high voltage generating circuit 6.

The display panel 1 is a video display panel based on a passive matrix system. The display panel 1 has a back substrate (not shown) and a front substrate (not shown) opposed to each other. On the back substrate, a plurality of data lines 32 and 33 extending in a column direction (Y-direction which is a vertical direction of the screen) are arrayed in a row direction (X-direction which is a horizontal direction of the screen) and a plurality of scan lines 31 extending in the row direction (X-direction) are arrayed in the column direction (Y-direction). Thin film type electron emitting elements (“thin film type” will be omitted as long as misunderstanding will not be caused) la are disposed in a matrix in intersection portions between the data lines and the scan lines respectively. On the front substrate, phosphors (not shown) are disposed oppositely to the electron emitting elements respectively.

The scan drivers 2 and 3 are connected to each scan line 31 of the display panel 1. The reason why the scan drivers 2 and 3 are disposed on the left and right sides of the display panel 1 is to reduce the luminance gradient caused by a voltage drop caused by the resistance belonging to the scan lines. In this system, identical scan signals are supplied to one and the same scan line 31 from its left and right sides. In this manner, this embodiment is arranged using two scan drivers, that is, the scan drivers 2 and 3. To simplify the system, the scan lines 31 may be driven by one of the left and right scan drivers. The scan drivers 2 and 3 apply selection signals to the scan lines sequentially from one scan line to the next so as to select a plurality of electron emitting elements 1a by row (one or two rows). Thus, the scan drivers 2 and 3 perform a selection operation (scan) over the rows in turn. The selection operation of the scan drivers 2 and 3 is executed based on a scan control signal Sscan which is a timing signal from the timing controller 7.

In FIG. 1, the display panel 1 is driven for display in the manner where the screen of the display panel is divided into an upper region and a lower region. However, the present invention may be applied to a configuration where the display panel 1 is driven for display in the manner where the screen of the display panel 1 is not divided into the upper and lower regions. The data driver 4 is connected to the data lines 32 in the upper region of the screen, and the data driver 5 is connected to the data lines 33 in the lower region of the screen.

The data drivers 4 and 5 supply driving signals to a plurality of electron emitting elements of the selected row through the data lines 32 and 33 in accordance with video data from the timing controller 7, respectively. The data drivers 4 and 5 hold data of one row of the display panel 1, that is, video data of one line from the timing controller 7 for one horizontal interval based on a timing signal from the timing controller 7. After one horizontal interval, the data are rewritten by data for the next row. Driving signals are supplied from the data driver 4 in a display interval of the upper region of the screen, and from the data driver 5 in a display interval of the lower region of the screen.

The high voltage generating circuit 6 supplies a high voltage to the front substrate through an anode line 34 of the display panel 1. On the front substrate, phosphors are disposed correspondingly to the electron emitting elements respectively.

The operation of the embodiment will be described below.

A selection signal (scan signal) outputted from the scan drivers 2 and 3 is applied to the scan lines 31. In a plurality of electron emitting elements 1a on one row (line) selected by the selection signal (scan signal), electrons are released. The amount of the electrons depends on the potential difference between the selection signal (scan signal) and a driving signal applied to the data lines 32 (33) by the data driver 4 (5). The voltage level of the selection signal applied for selecting the scan line 31 is constant regardless of the layout of the electron emitting elements. Thus, the amount of electrons released from each electron emitting element changes in accordance with the voltage level of the driving signal. That is, the amount of the electrons depends on the voltage level of a video signal on which the driving signal is based. On the other hand, an acceleration voltage (e.g. 7 kV) from the high voltage generating circuit 6 is applied to the anode line 34 of the display panel 1. For this reason, the electrons released from the electron emitting elements 1a are accelerated toward the front substrate due to the acceleration voltage, and collide with the phosphors disposed on the front substrate of the display panel 1. The phosphors are excited by the collision of the accelerated electrons. Thus, the phosphors emit light. In this manner, an image of the selected horizontal line is displayed. Further, the scan drivers 2 and 3 select the next scan line, and perform similar operation. Finally, all the scan lines of one screen are selected so that an image of one frame can be formed on the display screen of the display panel 1.

Next, description will be made on the operation of the video signal processing circuit 9, the compensation data generating circuit 8 and the timing controller 7.

A video signal inputted to a video signal terminal 10 is first inputted to the video signal processing circuit 9. The video signal processing circuit 9 performs format conversion upon the inputted video signal as to the number of pixels of the signal, the frequencies of sync signals, etc. so that the video signal can be displayed on the display panel 1 where the electron emitting elements are disposed in a matrix.

The video signal having a format converted by the video signal processing circuit 9 is inputted to the timing controller 7. The timing controller 7 generates a scan control signal Sscan based on the sync signals (horizontal sync signal and vertical sync signal) of the inputted video signal. The scan control signal Sscan is a timing signal for controlling the scan drivers 2 and 3 so that the scan drivers 2 and 3 can select and scan one of the scan lines of the display panel 1 each time. The scan control signal Sscan is outputted to the scan drivers 2 and 3. Thus, the scan drivers 2 and 3 sort the data of the inputted video signal in sync with the timing signal, and output the sorted data signal to the data drivers 4 and 5. Due to this operation, video data can be displayed on the display panel 1 in sync with the inputted video signal. In this embodiment, the screen of the display panel 1 is divided into two, i.e. the upper region and the lower region. For this reason, pixel data have to be sorted to display on the screen divided into the upper and lower regions. This sorting is performed by the timing controller 7.

The timing controller 7 also has a reverse-polarity signal generating function to generate a reverse-polarity signal. The reverse-polarity signal serves to apply a reverse bias voltage to electron emitting elements in order to prevent charges from being accumulated in the insulating layer (or a layer taking the place of the insulating layer) forming each thin film type electron emitting element.

In this embodiment, the timing controller 7 generates a signal (scan control signal Sscan) having a predetermined voltage value to be applied to each scan line of the display panel 1 in a display interval, and a signal (reverse-polarity signal) having a predetermined voltage value to be applied to all the scan lines in a vertical non-display interval. In the display interval, the scan drivers 2 and 3 switch the scan control signal Sscan from the timing controller 7 so as to apply the scan control signal Sscan to each scan line sequentially. In the vertical non-display interval, the scan drivers 2 and 3 apply the reverse-polarity signal to all the scan lines. It is a matter of course that a signal from the timing controller 7 may be controlled to a predetermined voltage value by the scan drivers 2 and 3.

Next, description will be made on the detailed operation of the timing controller 7 according to the present invention. As described previously, the timing controller 7 generates the scan control signal Sscan having a predetermined voltage value with polarity to allow electron emitting elements to emit electrons, so that the scan drivers 2 and 3 can select and scan the electron emitting elements in a row (line) each time in the display interval. The scan drivers 2 and 3 switch the scan control signal Sscan so as to apply the scan control signal Sscan to each scan line sequentially as a selection signal (scan signal). Thus, the scan drivers 2 and 3 select a row (line). The timing controller 7 generates a reverse-polarity signal such that the driving voltage for the electron emitting elements has a reverse direction to its regular direction in the vertical non-display interval. When the scan drivers 2 and 3 receive the input of the reverse-polarity signal, the scan drivers 2 and 3 apply the reverse-polarity signal to all the scan lines simultaneously. Since the driving voltage applied to the electron emitting elements has a reverse direction to its regular direction, electrons accumulated in the electron emitting elements are released. Thus, the electron emitting elements are prevented from accumulating electrons continuously, so that the lives of the electron emitting elements can be elongated.

The compensation data generating circuit 8 is a circuit which generates a data line voltage for compensating the voltage applied to each electron emitting element so as to solve a problem that the voltage of the reverse-polarity signal drops down in each electron emitting element terminal due to the resistance of the scan line. As shown in FIG. 1, when the electron emitting elements are driven by the scan drivers 2 and 3 on the opposite sides of the display panel 1, electron emitting elements located in the center portion of the screen have longer distances from the scan drivers. Thus, the wiring resistance between the output terminal of each scan driver 2, 3 and the terminal of each electron emitting element located in the center portion also becomes large. Thus, the voltage drop caused by the resistance of the scan line increases so that the scan voltage in the terminal of the electron emitting element becomes lower than the scan voltage applied to the terminal of an electron emitting element located in an end of the screen. A current released by an electron emitting element depends on a differential voltage between the scan voltage at the terminal of the electron emitting element and the data line voltage. It is therefore necessary to increase the compensation value for the data line voltage corresponding to the center portion of the screen. On the contrary, when an electron emitting element is close to the scan driver 2 or 3, the amount of a voltage drop caused by the resistance of the scan line is small. Accordingly, suitable compensation can be performed by reducing the compensation value for the data line voltage. In this manner, the compensation data generating circuit 8 changes the compensation value in accordance with the distance between each electron emitting element and the scan driver so as to generate a proper compensation value.

When the electron emitting elements are driven by the scan drivers 2 and 3 as in this embodiment, there occurs a maximum voltage drop in the center portion of the screen. When the electron emitting elements are driven by one scan driver 2 or 3, there occurs a maximum voltage drop in an end portion of the screen on the opposite side of an end portion where the scan driver supplies a scan line signal. Also in this case, the compensation data generating circuit 8 generates a compensation value corresponding to a horizontal position of the screen corresponding to each data line.

The compensation data generating circuit 8 generates compensation data for the data lines, and outputs the compensation data to the timing controller 7 in a period designated by a vertical blanking interval gate 81. The timing controller 7 sends the value of the output of the compensation data generating circuit 8 to the data drivers 4 and 5 in a vertical blanking interval. The data drivers 4 and 5 then output compensation data in accordance with a display position in the vertical blanking interval. On the other hand, the scan drivers 2 and 3 output a reverse-polarity signal in this interval. A differential voltage between the reverse-polarity signal outputted from the scan drivers 2 and 3 and the compensation data outputted from the data drivers 4 and 5 is applied to each electron emitting element. Thus, a predetermined reverse-polarity voltage is applied to each electron emitting element in spite of the wiring resistance. It is therefore possible to improve the lives of the electron emitting elements uniformly all over the screen.

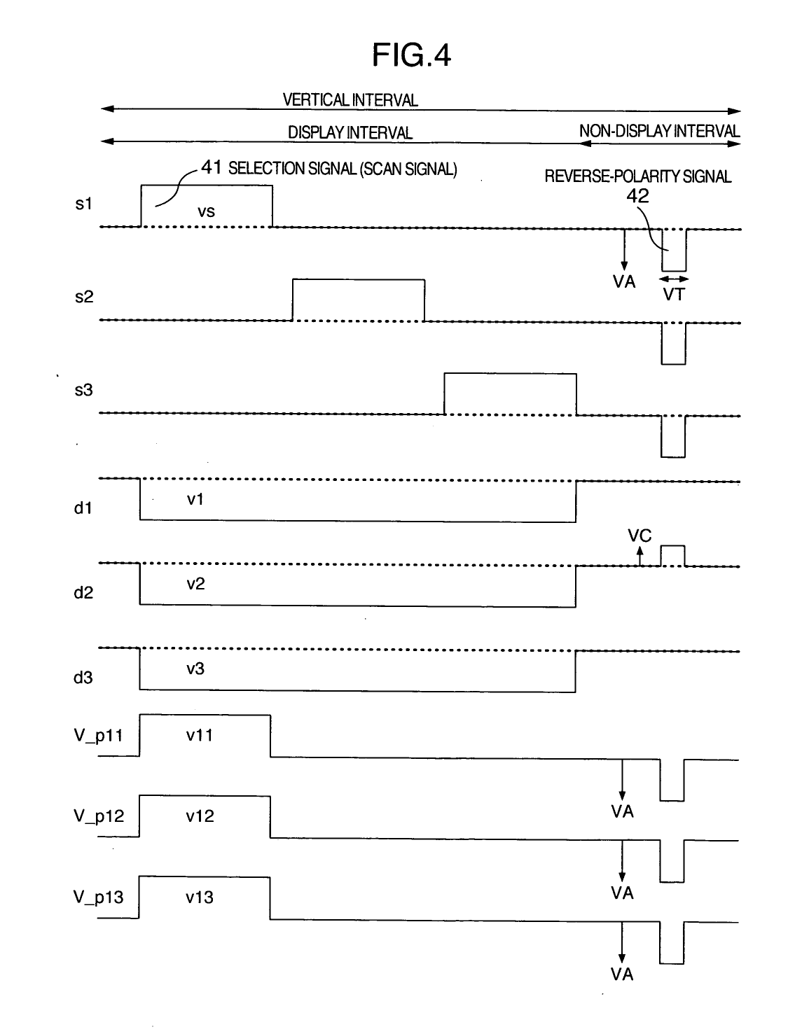

The operation of the compensation data generating circuit 8 will be described in detail with reference to FIG. 4. FIG. 4 is a timing chart in a display apparatus constituted by electron emitting elements arrayed in three scan lines and three data lines. FIG. 4 shows waveforms of scan line signals s1, s2 and s3 for driving the scan lines, waveforms of data signals d1, d2 and d3, and waveforms of voltages v_p11, v_p12 and v_p13 applied between opposite ends of electron emitting elements p11, p12 and p13 respectively. In FIG. 4, a video signal by which a display image will be totally blank is inputted.

In FIG. 4, each scan line signal s1, s2, s3 is set in a level vs in order to designate an interval to select a scan line. In a vertical blanking interval which is a non-display interval, the scan line signal s1, s2, s3 is set to output a reverse-polarity signal for a period VT in order to allow electron emitting elements to release charges accumulated in their insulating layers.

The electron emitting elements p11, p21 and p31 on the left end of the display screen are located just closely to the output of the scan driver 2. The reverse-polarity signal supplied to the electron emitting elements p11, p21 and p31 is hardly affected by the resistance of the scan lines. In this case, it is hardly necessary to compensate the voltage drop of the reverse-polarity signal caused by the resistance of the scan lines. Therefore, compensation in the period of the reverse-polarity signal does not have to be performed upon the electron emitting elements p11, p21 and p31. The waveform of the data signal d1 shows the waveform in this case. In the non-display interval of the data signal d1, the compensation value of the reverse-polarity signal is zero as described above. In the same manner, the electron emitting elements p13, p23 and p33 on the right end of the display screen are located just closely to the output of the scan driver 3 so that the reverse-polarity signal supplied to the electron emitting elements p13, p23 and p33 is hardly affected by the resistance of the scan lines. In this case, it is hardly necessary to compensate the voltage drop of the reverse-polarity signal caused by the resistance of the scan lines. Therefore, compensation in the period of the reverse-polarity signal does not have to be performed upon the electron emitting elements p13, p23 and p33. The waveform of the data signal d3 shows the waveform in this case. In the non-display interval of the data signal d3, the compensation value of the reverse-polarity signal is zero as described above.

On the other hand, the electron emitting elements p12, p22 and p32 located in the center of the display screen are disposed at distances from the scan drivers 2 and 3. The reverse-polarity signal supplied to the electron emitting elements p12, p22 and p32 is greatly affected by the resistance of the scan lines. In this case, it is therefore necessary to compensate the voltage drop of the reverse-polarity signal caused by the resistance of the scan lines. Compensation in the period of the reverse-polarity signal is performed upon the electron emitting elements p12, p22 and p32. The compensation value may be determined in accordance with the resistance value of the scan lines. The waveform of the data signal d2 shows the waveform in this case. In the non-display interval of the data signal d2, the compensation value of the reverse-polarity signal is set as described above. The value is vc.

FIG. 4 shows the voltages to be applied to the electron emitting elements p11, p12 and p13 in this embodiment. If compensation were not performed on the reverse-polarity signal, the voltage of the reverse-polarity signal applied to the electron emitting element p12 would be expressed by VA−vc due to the voltage drop occurring due to the resistance of the scan line. However, due to compensation with the value vc performed through the data signal d2, the voltage of the reverse-polarity signal is expressed by (VA−vc)+Vc=VA. Thus, the same reverse-polarity signal as that to any other electron emitting element can be applied to the electron emitting element p12. As a result, the property of restoring the lives of the electron emitting elements becomes uniform all over the screen. Even after a long time has passed, there does not occur screen deterioration that a part of the screen gets dark. It is therefore possible to elongate the life of the display panel uniformly.

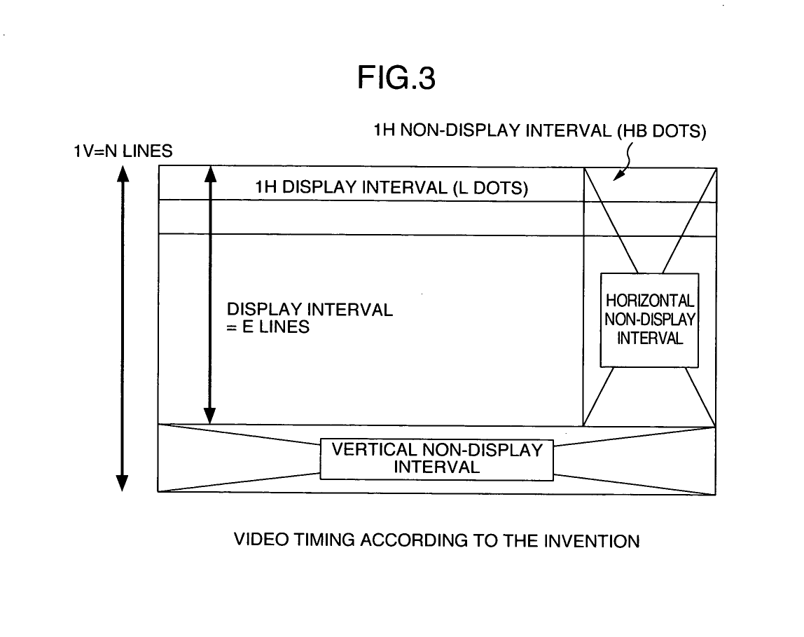

FIG. 3 shows the aforementioned idea about the non-display interval. FIG. 3 is a diagram showing the relationship among the display interval, the non-display interval, the selection signal period and the reverse-polarity signal period. That is, according to the present invention, as shown in FIG. 3, display is performed in a period which is in a vertical non-display interval TV_{OFF} of an video image and in a 1H display interval, and display is suspended in a horizontal non-display interval and in a vertical non-display interval. In the aforementioned description, the reverse-polarity signal is set in the vertical non-display interval.

It is a matter of course that the vertical non-display interval TV_{OFF} and the reverse-polarity signal period TE_{R} are set to have optimum values in accordance with a pulse amplitude value VA of the reverse-polarity signal. For example, a table of vertical non-display intervals TV_{OFF} and reverse-polarity signal periods TE_{R} corresponding to a plurality of pulse amplitude values of the reverse-polarity signal is prepared in advance. When a pulse amplitude value of the reverse-polarity signal is designated by a not-shown input unit or on a menu screen, an optimum vertical non-display interval TV_{OFF} and an optimum reverse-polarity signal period TE_{R} can be set.

According to this embodiment, as described above, the voltage of the reverse-polarity pulse signal to be supplied can be made substantially uniform over the electron emitting elements. It is therefore possible to cancel the nonuniformity of deterioration over the electron emitting elements caused by the resistance of the scan lines. In addition, charges accumulated in the insulating layer of each electron emitting element can be released sufficiently regardless of the position where the electron emitting element is arranged. It is therefore possible to elongate the lives of the electron emitting elements uniformly over the display screen.

### [Embodiment 2]

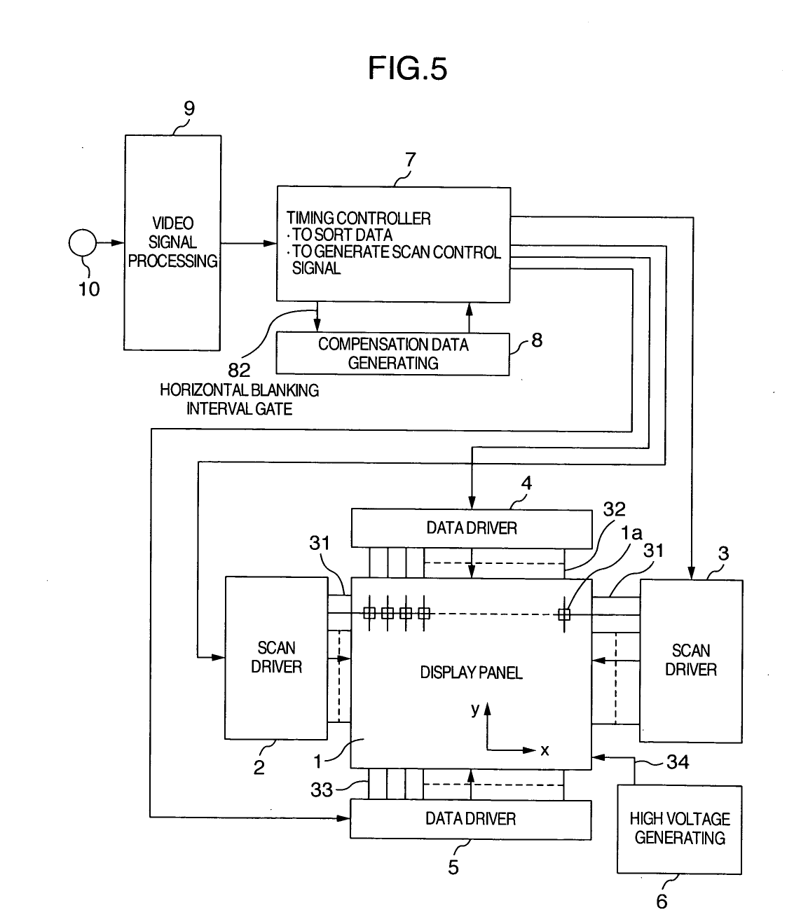

Next, a second embodiment for compensation of the value of a reverse-polarity signal will be described with reference to FIG. 5. Most parts of the block configuration diagram of a display apparatus according to this embodiment are the same as those in FIG. 1. Parts having the same functions as those in FIG. 1 are referenced correspondingly, and description thereof will be omitted.

FIG. 5 is the same as FIG. 1, except that the signal supplied to the compensation data generating circuit 8 by the timing controller 7 is a horizontal blanking interval gate 82. This embodiment is different from Embodiment 1 in that not a vertical blanking interval but a horizontal blanking interval is used as a non-display interval when a reverse-polarity signal should be sent to the display panel 1.

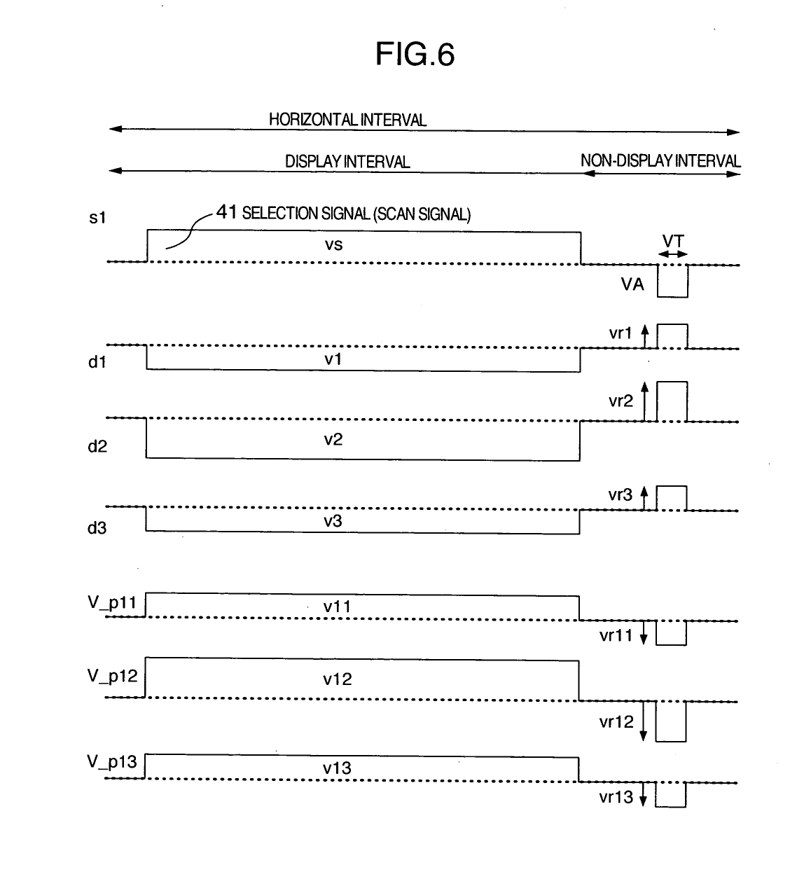

In FIG. 5, in response to the horizontal blanking interval gate 82, the compensation data generating circuit 8 creates compensation data for each data row, and the created output of the compensation data generating circuit 8 is sent to the timing controller 7. The timing controller 7 outputs a reverse-polarity signal to the scan drivers 2 and 3 in a horizontal blanking interval which is a non-display interval, and outputs a data signal compensated with the output of the compensation data generating circuit 8 to the data drivers 4 and 5. The operation waveform diagram of FIG. 6 shows timings about this operation.

FIG. 6 includes the waveform of a scan line signal s1 for driving a corresponding scan line. The scan line signal s1 reaches a level vs in a horizontal display interval so as to select the corresponding scan line. In a horizontal non-display interval, the scan line signal s1 is outputted as a reverse-polarity signal whose level is VA.

FIG. 6 shows a timing chart for a display apparatus constituted by electron emitting elements arranged in three scan lines and three data lines in the same manner as in Embodiment 1. FIG. 6 shows a waveform of the scan line signal s1 for driving a first line, waveforms of data signals d1, d2 and d3, and waveforms of voltages v_p11, v_p12 and v_p13 applied between opposite ends of electron emitting elements p11, p12 and p13 respectively. In FIG. 6, a video signal by which a display image will be totally blank is inputted.

In FIG. 6, the scan line signal s1 is outputted in the level vs when a scan line is selected in a display interval, and outputted as the reverse-polarity signal in a horizontal blanking interval which is a non-display interval. The level of the reverse-polarity signal on this occasion is VA and the width thereof is VT.

On the other hand, description will be made on the data signals. The electron emitting elements p11, p21 and p31 on the left end of the display screen are located just closely to the output of the scan driver 2. The reverse-polarity signal supplied to the electron emitting elements p11, p21 and p31 is hardly affected by the resistance of the scan lines. For the electron emitting elements p11, p21 and p31, therefore, it is not necessary to compensate the voltage drop of the reverse-polarity signal caused by the resistance of the scan lines. Therefore, compensation in the period of the reverse-voltage signal may be low for the electron emitting elements p11, p21 and p31. The waveform of the data signal d1 shows the waveform in this case. In the non-display interval of the data signal d1, the compensation value of the reverse-polarity signal is vr1. In the same manner, the electron emitting elements p13, p23 and p33 on the right end of the display screen are located just closely to the output of the scan driver 3 so that the reverse-polarity signal supplied to the electron emitting elements p13, p23 and p33 is hardly affected by the resistance of the scan lines. In this case, therefore, it is hardly necessary to compensate the voltage drop of the reverse-polarity signal caused by the resistance of the scan lines. Therefore, compensation in the period of the reverse-voltage signal may be low for the electron emitting elements p13, p23 and p33. The waveform of the data signal d3 shows the waveform in this case. In the non-display interval of the data signal d3, the compensation value of the reverse-polarity signal is vr3.

On the other hand, the electron emitting elements p12, p22 and p32 located in the center of the display screen are disposed at distances from the scan drivers 2 and 3. The reverse-polarity signal supplied to the electron emitting elements p12, p22 and p32 is greatly affected by the resistance of the scan lines. In this case, it is therefore necessary to greatly compensate the voltage drop of the reverse-polarity signal caused by the resistance of the scan lines. Compensation in the period of the reverse-voltage signal is performed upon the electron emitting elements p12, p22 and p32. The compensation value may be determined in accordance with the resistance value of the scan lines. The waveform of the data signal d2 shows the waveform in this case. In the non-display interval of the data signal d2, the compensation value of the reverse-polarity signal is set as described above. The value is vr2.

FIG. 4 shows voltages V_p11, V_p12 and V_p13 to be applied to the electron emitting elements p11, p12 and p13 respectively in this embodiment. If compensation were not performed on the reverse-polarity signal, a voltage drop due to the resistance of the scan line would occur in the voltage of the reverse-polarity signal applied to the electron emitting element p12. However, due to compensation with the data signal vr2, the voltage of the reverse-polarity signal reaches vr12. Thus, the reverse-polarity signal with the same voltage as that to any other electron emitting element can be applied to the electron emitting element p12. As a result, the property of restoring the lives of the electron emitting elements becomes uniform all over the screen. Even after a long time has passed, there does not occur screen deterioration that a part of the screen gets dark. It is therefore possible to elongate the life of the display panel uniformly.

### [Embodiment 3]

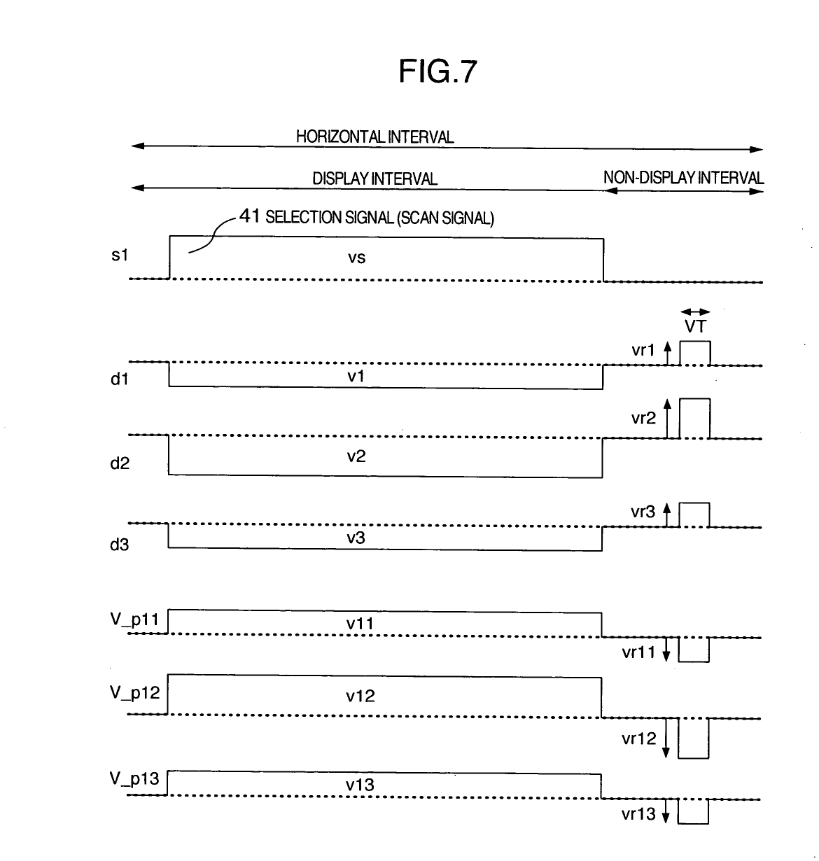

Next, a third embodiment for compensation of the value of a reverse-polarity signal will be described with reference to FIG. 7. The block configuration diagram of a display apparatus according to this embodiment is the same as that in FIG. 5, and description thereof will be omitted.

FIG. 7 includes the waveform of a scan line signal s1 for driving a corresponding scan line. The scan line signal s1 reaches a level vs in a horizontal display interval so as to select the corresponding scan line. In a horizontal non-display interval, the scan line signal s1 is outputted in a level 0.

FIG. 7 is a timing chart for a display apparatus constituted by electron emitting elements arranged in three scan lines and three data lines in the same manner as in Embodiment 1. FIG. 7 shows a waveform of the scan line signal s1 for driving a first line, waveforms of data signals d1, d2 and d3, and waveforms of voltages v_p11, v_p12 and v_p13 applied between opposite ends of electron emitting elements p11, p12 and p13 respectively. In FIG. 7, a video signal by which a display image will be totally blank is inputted.

In FIG. 7, the scan line signal s1 is outputted not as the reverse-polarity signal but in the level vs when a scan line is selected in a display interval. This embodiment can be regarded as Embodiment 2 where the level VA of the reverse-polarity signal is 0. In place of the reverse-polarity signal, the compensation value of each data signal may be changed. The operation of each signal is the same as that in FIG. 6, so that description thereof will be omitted. With the configuration of FIG. 7, it is not necessary to insert the reverse-polarity signal. It is therefore possible to simplify the circuit. Effect almost the same as that of the embodiment shown in FIG. 6 can be obtained in this embodiment.

### [Embodiment 4]

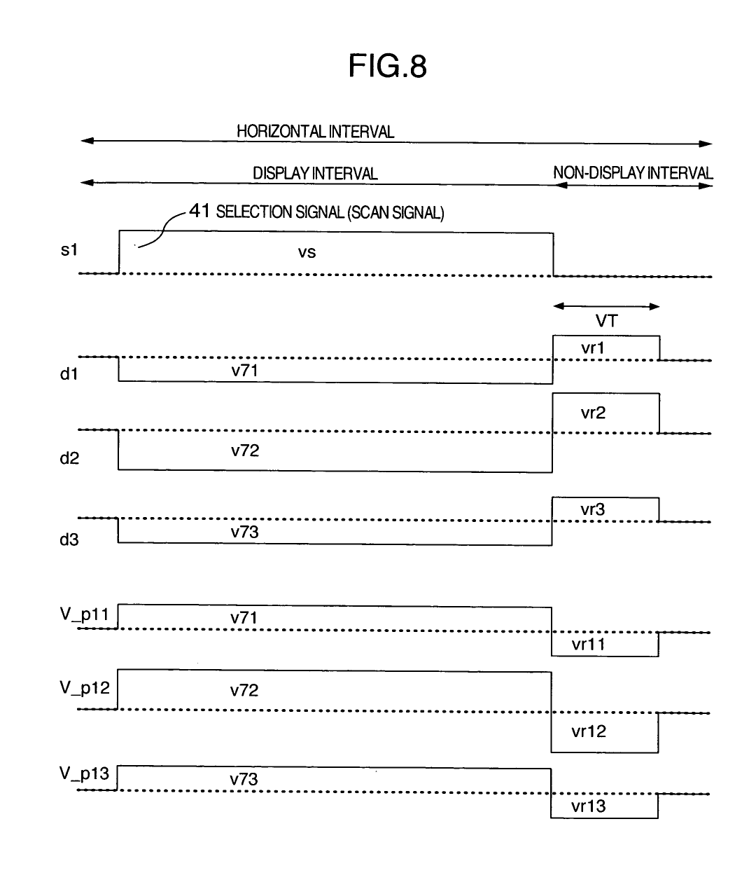

Further another embodiment will be described with reference to FIG. 8. The block configuration diagram of a display apparatus according to this embodiment is the same as that of Embodiment 2 or 3, and description thereof will be omitted.

FIG. 8 includes the waveform of a scan line signal s1 for driving a corresponding scan line. The scan line signal s1 reaches a level vs in a horizontal display interval so as to select the corresponding scan line. In a horizontal non-display interval, the scan line signal s1 is outputted in a level 0.

FIG. 8 is a timing chart for a display apparatus constituted by electron emitting elements arranged in three scan lines and three data lines in the same manner as in Embodiment 1. FIG. 8 shows a waveform of the scan line signal s1 for driving a first line, waveforms of data signals d1, d2 and d3, and waveforms of voltages v_p11, v_p12 and v_p13 applied between opposite ends of electron emitting elements p11, p12 and p13 respectively. In FIG. 8, a video signal by which a display image will be totally blank is inputted.

In FIG. 8, the scan line signal s1 is outputted not as the reverse-polarity signal but in the level vs when a scan line is selected in a display interval. This embodiment can be regarded as Embodiment 3 where the scan signal and the reverse-polarity signal are made contiguous in order to improve the compensation effect of each data signal, so as to increase the period of time when the reverse-polarity signal is applied to electron emitting elements in a non-display interval. The operation of each signal is the same as that in FIG. 7, so that description thereof will be omitted. With the configuration of FIG. 8, it is not necessary to insert the reverse-polarity signal. It is therefore possible to simplify the circuit. In addition, it is possible to increase the period of time when the reverse-polarity signal is applied. Thus, the effect of improving the life can be increased.

### [Embodiment 5]

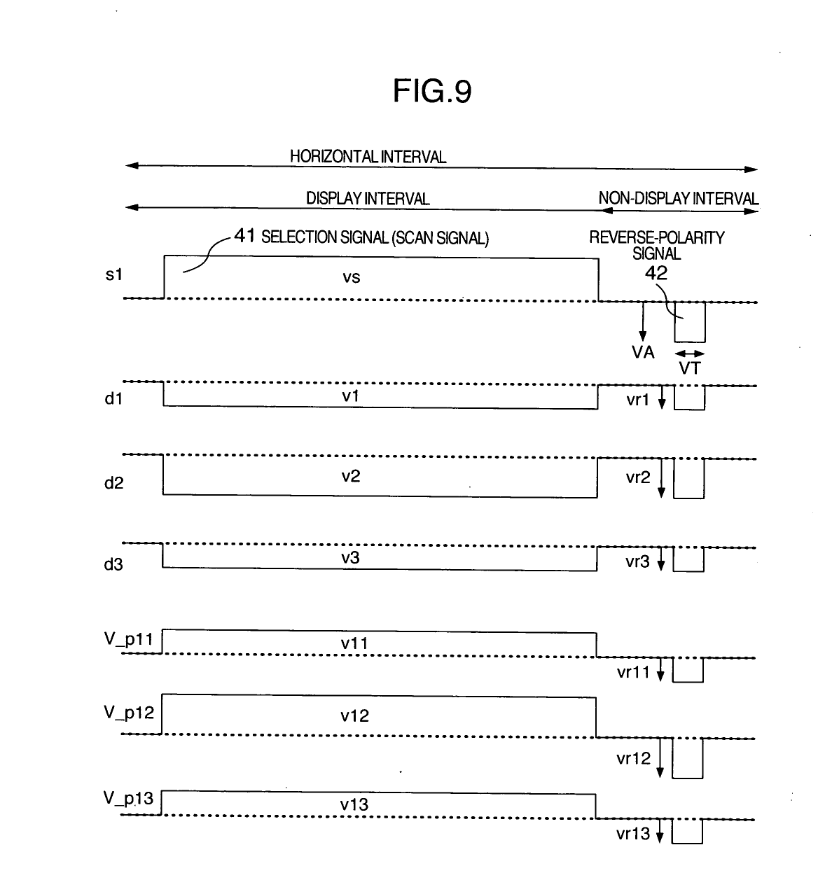

Further another embodiment will be described with reference to FIG. 9. The block configuration diagram of a display apparatus according to this embodiment is the same as that of Embodiment 2 or 3, and description thereof will be omitted.

FIG. 9 includes the waveform of a scan line signal s1 for driving a corresponding scan line. The scan line signal s1 reaches a level vs in a horizontal display interval so as to select the corresponding scan line. In a horizontal non-display interval, the scan line signal s1 is outputted as a reverse-polarity signal whose level is VA.

FIG. 9 is a timing chart for a display apparatus constituted by electron emitting elements arranged in three scan lines and three data lines in the same manner as in Embodiment 1. FIG. 9 shows a waveform of the scan line signal s1 for driving a first line, waveforms of data signals d1, d2 and d3, and waveforms of voltages v_p11, v_p12 and v_p13 applied between opposite ends of electron emitting elements p11, p12 and p13 respectively. In FIG. 9, a video signal by which a display image will be totally blank is inputted.

In FIG. 9, the scan line signal s1 is outputted in the level vs when a scan line is selected in a display interval, and outputted as the reverse-polarity signal in a non-display interval. This embodiment can be regarded as Embodiment 3 where the voltage of the reverse-polarity signal is set to be large, and the compensation value of each data signal is reduced, so that the circuitry of the driving circuit for the data signal can be simplified. The operation of each signal is the same as that in FIG. 7, so that description thereof will be omitted. With the configuration of FIG. 9, the life can be improved.

While we have shown and described several embodiments in accordance with our invention, it should be understood that disclosed embodiments are susceptible of changes and modifications without departing from the scope of the invention. Therefor, we do not intend to be bound by the details shown and described herein but intend to cover all such changes and modifications a fall within the ambit of the appended claims.

1. A display apparatus comprising:
a plurality of scan lines;
a scan line driving circuit connected to at least left or right ends of the plurality of scan lines so as to apply a scan voltage to the plurality of scan lines;
a plurality of data lines;
a data line driving circuit connected to the plurality of data lines so as to apply a driving voltage to the plurality of data lines in accordance with an inputted video signal;
electron emitting elements connected to intersection portions between the plurality of scan lines and the plurality of data lines respectively so as to emit electrons in accordance with a potential difference between the scan voltage and the driving voltage; and
a control module; wherein:
the control module controls the scan line driving circuit and/or the data line driving circuit so as to apply a reverse-polarity voltage to the electron emitting elements in accordance with the electron emitting elements, the reverse-polarity voltage having reverse polarity to the voltage applied to the electron emitting elements.

2. A display apparatus according to claim 1, wherein:
the scan line driving circuit is connected to opposite ends of the plurality of scan lines;
the electron emitting elements include first electron emitting elements and second electron emitting elements disposed more closely to a center side of the scan lines than the first electron emitting elements; and
the control module controls the scan line driving circuit and/or the data line driving circuit so as to apply the reverse-polarity voltage to the electron emitting elements so that the reverse-polarity voltage applied to the second electron emitting elements is larger than that applied to the first electron emitting elements.

3. A display apparatus according to claim 1, wherein:
the scan line driving circuit is connected to left or right ends of the plurality of scan lines;
the electron emitting elements include first electron emitting elements and second electron emitting elements disposed between the first electron emitting elements and the scan line driving circuit; and
the control module controls the scan line driving circuit and/or the data line driving circuit so as to apply the reverse-polarity voltage to the electron emitting elements so that the reverse-polarity voltage applied to the first electron emitting elements is larger than that applied to the second electron emitting elements.

4. A display apparatus according to claim 1, wherein:
the control module controls the scan line driving circuit and/or the data line driving circuit so as to apply the reverse-polarity voltage to the electron emitting elements in a non-display interval of the video signal, the reverse-polarity voltage having reverse polarity to the voltage applied to the electron emitting elements.

5. A display apparatus according to claim 4, wherein:
the non-display interval is a horizontal blanking interval or a vertical blanking interval of the video signal.

6. A display apparatus according to claim 1, further comprising:
a generating circuit to generate a reverse-polarity voltage value to be applied to the electron emitting elements, in accordance with a wiring resistance value of the scan lines; wherein:
the control module controls the scan line driving circuit and/or the data line driving circuit so as to apply the reverse-polarity voltage to the electrode emitting elements based on data generated by the generating circuit, the reverse-polarity voltage having reverse polarity to the voltage applied to the electron emitting elements.

7. A display apparatus according to claim 4, wherein:
the control module controls the scan line driving circuit and/or the data line driving circuit so as to apply the reverse-polarity voltage to the electrode emitting elements contiguously to a display interval of the video signal.

8. A display apparatus according to claim 1, wherein:
the electron emitting elements are disposed in a matrix.

9. A display apparatus comprising:
a plurality of scan lines;
a scan driver connected to at least left or right ends of the plurality of scan lines so as to apply a scan voltage to the plurality of scan lines sequentially;
a plurality of data lines;
a data driver connected to the plurality of data lines so as to apply a driving voltage to the plurality of data lines in accordance with an inputted video signal;
electron emitting elements connected to intersection portions between the plurality of scan lines and the plurality of data lines respectively so as to emit electrons in accordance with a potential difference between the scan voltage and the driving voltage; and
a control module which controls the scan driver and/or the data driver so as to apply a reverse-polarity voltage to the electron emitting elements in accordance with distances of the electron emitting elements from the scan driver, the reverse-polarity voltage having reverse polarity to the voltage applied to the electron emitting elements.
